(19) United States
(12) Patent Application Publication
(10) Pub. No.: US 2013/0311286 A1
(43) Pub. Date: Nov. 21, 2013

(54) SYSTEMS AND METHODS FOR FACILITATING DETERMINATION OF MARKETING INFORMATION FOR ONLINE CONSUMERS BASED ON A LOCATION CHARACTERISTIC OF THE ONLINE CONSUMER

(71) Applicant: Engauge Innovations, LLC., Columbus, OH (US)

(72) Inventor: John Jason Detwiler, Lewis Center, OH (US)

(73) Assignee: Engauge Innovations, LLC., Columbus, OH (US)

(21) Appl. No.: 13/896,580

(22) Filed: May 17, 2013

Related U.S. Application Data
(60) Provisional application No. 61/648,264, filed on May 17, 2012.

(51) Int. Cl. G06Q 30/02

(52) U.S. Cl. CPC G06Q 30/0255
USPC 705/14.54; 705/14.53

(57) ABSTRACT

In accordance with some embodiments, a location based marketing service is operable to select and output to a user device a marketing offer (e.g., a coupon or price matching certificate) based on (i) a location characteristic of at least one of the user device and a user associated with the user device; and (ii) online activity of the user (e.g., a key word search performed by the user or a product web page visited by the user). In accordance with some embodiments, the marketing offer is redeemable at a merchant within a predetermined distance of the user, as determined by the location characteristic of the user. In accordance with one embodiment, the location characteristic of the user is determined based on an IP address of a user device associated with the user.

### CLAIM OF PRIORITY

The present application claims the benefit of U.S. Provisional Patent Application No. 61/648,264, filed May 17, 2012 in the name of John Jason Detwiler and entitled METHOD AND APPARATUS FOR FACILITATING DETERMINATION OF MARKETING INFORMATION FOR ONLINE CONSUMERS. The entirety of this application is hereby incorporated by reference herein for all purposes.

### BRIEF DESCRIPTION OF THE FIGURES

The foregoing and other features, aspects and advantages of the invention(s) described herein are described in detail below with reference to the drawings of various embodiments, which are intended to illustrate and not to limit the invention(s). The drawings comprise the following figures in which:

FIG. 1 is a block diagram of an example system according to an embodiment of the present disclosure.

FIG. 2 is a block diagram of an example user device according to an embodiment of the present disclosure.

FIG. 3 is a block diagram of an example marketing offer server according to an embodiment of the present disclosure.

FIG. 4 is a block diagram of an example merchant server according to an embodiment of the present disclosure.

FIG. 5 is an example user interface for outputting an offer for a coupon via a web browser interface according to an embodiment of the present disclosure.

FIG. 6 is a tabular representation of a portion of a coupon database according to an embodiment of the present disclosure.

FIG. 7 is a tabular representation of a portion of a merchant database according to an embodiment of the present disclosure.

FIG. 8 is a flow chart illustrating an example process according to an embodiment of the present disclosure.

FIG. 9 is a flow chart illustrating another example process according to an embodiment of the present disclosure.

### DETAILED DESCRIPTION OF VARIOUS EMBODIMENTS

Applicant has recognized that brick-and-mortar merchants may be able to attract consumers to their establishments based on online activities of such users. Applicant has further recognized that brick-and-mortar merchants have limited resources for marketing their products and services to consumers and would benefit from a mechanism which allows them to target marketing offers to consumers who are, or are likely to be, near their brick-and-mortar establishments. Accordingly, consistent with some embodiments of the present disclosure, Applicant describes herein various processes, systems and articles of manufacture (e.g., software) which provide for outputting marketing offers to online users, based on a location characteristic of the user and online activity of the user, the marketing offers being for brick-and-mortar locations of merchants.

For example, in accordance with some embodiments various systems, methods and articles of manufacture described herein provide for the determination and output of marketing information such as marketing offers (e.g., digital coupons from local brick and mortar merchants) to at least one user, based on online information output to the user and based on a location characteristic of the user. In some embodiments, the marketing offer may be output to the user while the user is browsing the Internet, when the result(s) of a keyword search are output to the user or when a web page of a product or service is being output to the user. In some embodiments the location characteristic may comprise a location associated with the user (e.g., a zip code or other location information provided by the user). Location information provided by the user may comprise, for example, a current location of the user, a location the user intends to visit (e.g., based on vacation plans, a commuting pattern, etc.) and/or a location the user frequently visits. In some embodiments, the location characteristic may comprise a location characteristic of at least one user device associated with the user (e.g., the IP address of the user device and/or a GPS-determined location of the user device).

It should be noted that in some embodiments, a marketing offer may be output to a user based on a location characteristic of a user and online information previously output to a user (i.e., online information output to the user at a time prior to the time at which the marketing information is output). For example, a marketing offer may be output to the user based on a website previously visited by the user, a web page previously visited by the user, a keyword search previously conducted by the user, etc. In some embodiments, such previously output online information may be combined with currently output online information and a marketing offer may be determined based on the combination of such online information. In some embodiments, a marketing offer selected based on a location characteristic of a user and online information previously output to the user may be output to the user the next time the user launches his web browser or otherwise accesses the location based marketing offer service which outputs such marketing offers.

It should be noted that online information comprises any information (e.g., text, video files, audio files, web pages, listings of search results, etc.) output to a user via a display of a computing device (e.g., a user device, as described in detail herein) while the computing device is connected over a network to another computing device. For example, online information may comprise information output to the user via a display of a computing device connected to one or more server computers over the Internet.

In one non-limiting example of an embodiment, a gardening brick-and-mortar store could elect to have a “$10 off on garden shears” digital coupon be output to a user in response to it being determined (i) that the user typed the key words “garden” and “shears” into a web browser or search engine and (ii) that the user is located within 5 miles of the store (or it was determined that the user was going to be within 5 miles of the store). In another embodiment, the “$10 off on garden shears” digital coupon may be output to the user at some point in time after it is determined that the user typed in the key words “garden” and “shears” (e.g., an indication of the user's key word search may be stored and, if it is determined that the user is or is going to be within 5 miles of the store, the digital coupon may be output to the user via the user's mobile device).

In another example, a That food restaurant could choose to have a “two for one entree lunch special” digital coupon be shown to users visiting a Yelp page and searching for That food, but only if it was determined that the user was sufficiently associated with the zip code or other location-based characteristic of the restaurant (e.g., it was determined that the user was currently located within the zip code, resided within the zip code or was going to be traveling within the zip code of the restaurant). In some embodiments, if an offer from a merchant is entered into the system which corresponds to criteria satisfied by previous online activity of a user (e.g., key word search of a previous search by a user and location characteristic of user fit criteria for outputting the offer to the user), the offer may be output to the user the next time the user launches his web browser or otherwise engages the services of the location based marketing offer service described herein.

It should be noted that references to a user herein may be interchanged with references to a user device in accordance with some embodiments. For example, when it is referred to herein that a user is associated with a location, is in a location or is within some predetermined distance of a location, it is intended to encompass at least one of the user himself/herself and any user device of such a user as being so associated with a location, in a location or within some predetermined distance of the location. Thus, in some embodiments, the term user and user device may be interpreted as being interchangeable.

The term coupon, as it is used herein unless indicated otherwise, refers to a marketing offer which, when redeemed by a user, entitles the user to receive a discount or other benefit or reward (e.g., additional features at no extra cost or supplementary items at no cost). Coupons may be provided to potential users with a written offer on each coupon, and may be accompanied by an offer code (such as a bar code) designed to identify the offer to a point-of-sale (POS) terminal. A POS may comprise, for example, a computing device at a brick-and-mortar merchant location via which a user is able to effectuate a purchase of a product or service and/or redeem a coupon. In some embodiments, a POS may comprise an aspect, feature or component of an online merchant which allows a user to effectuate a purchase or redemption of a coupon online.

A user may be able to redeem more than one coupon for some transactions, though in some embodiments a user may be required to present all of the individual coupons at the POS terminal where each coupon corresponds with a particular product, transaction, event or service for which the coupon has been issued. A digital or online coupon, as the term is used herein unless indicated otherwise, may refer to a coupon which is presented to an online consumer via a web page and/or website and may be redeemed at an online merchant and/or printed out or displayed (e.g., via a mobile device) at a POS of a brick-and-mortar merchant for redemption. A digital or online coupon may also be referred to as or comprise, for example, a coupon code, promotional code, promo code or reward code.

Embodiments of the present disclosure are directed to systems and methods to generate, store, prioritize and distribute marketing offers such as digital coupons that are related to a physical location characteristic of the user to whom the marketing offers are presented. It should be noted that although many of the embodiments described herein are described in terms of digital coupons (for purposes of brevity), the embodiments may be applied to other types of marketing offers or marketing information.

Certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention(s) described herein extends beyond the specifically disclosed embodiments, examples and illustrations and includes other uses of the invention(s) and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the inventions herein described.

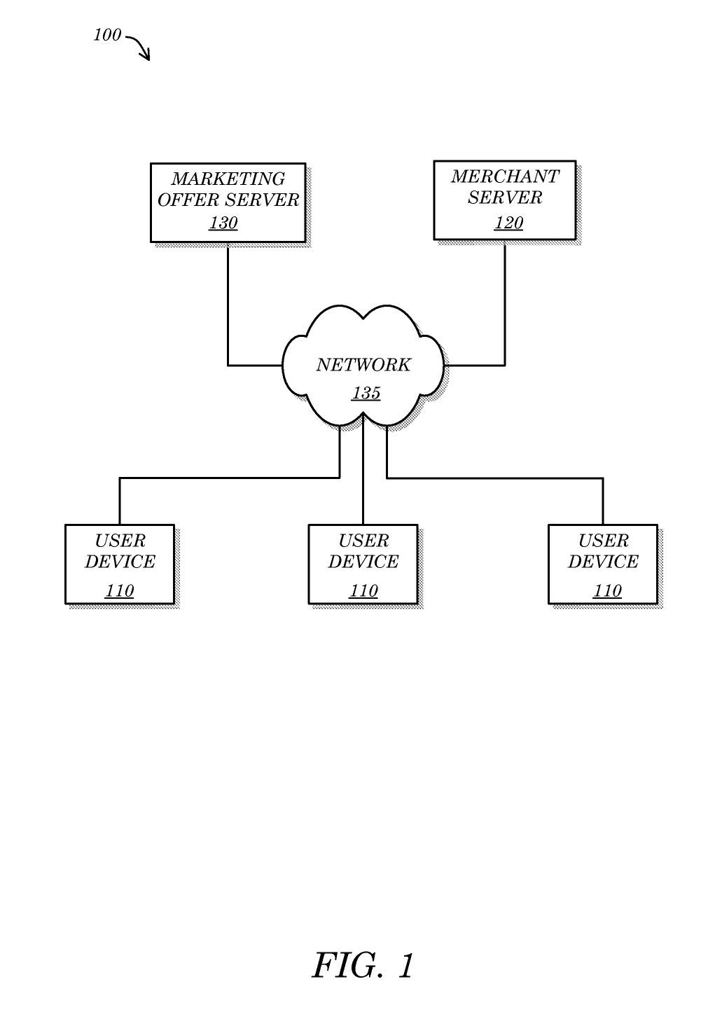

Turning now in detail to the drawings, FIG. 1 is a block diagram of an example system 100 according to one embodiment of the present disclosure. The coupon system 100 includes a plurality of user devices 110, a merchant server 120 and a marketing offer server 130. Any number of any of the different types of devices 110, 120 and 130 may be incorporated in the system 100. As is described in detail herein, the configurations of a system operable to facilitate embodiments described herein may vary depending on at least one of the characteristics, requirements and features of at least one of the digital coupon(s) being offered, the merchants participating in the system and the entity operating the location based marketing offer service. For example, concerns or desirable parameters related to at least one of security, information tracking and financial resources of the merchants may impact a configuration of a desirable system.

In some embodiments, any of the user device 110, the merchant server 120 and the marketing offer server 130 may be operable to communicate with one another via a network 135. The network 135 may comprise, for example, a cellular, satellite or pager network, the Internet, a wide area network, another network or a combination of two or more of such networks. The network 135 may be operable to facilitate the routing of communications among the devices of system 100. It should be understood that although not shown in FIG. 1, more than one type of network may be included in the system 100 (e.g., user device 110 may communicate with the marketing offer server 130 via a first type of network while the marketing offer server 130 communicates with a merchant server 120 via a second type of network). For example, in one embodiment, both the Internet and a wireless cellular network may be involved in routing communications among two or more components of the system 100.

In some embodiments, additional devices that are not show in FIG. 1 may be part of a system 100. For example, one or more servers operable to serve as wireless network gateways or routers may be part of system 100. In other embodiments, some of the functionality described herein as being performed by marketing offer server 130 may instead or in addition be performed by a third party server operating on behalf of the marketing offer server 130 (e.g., the location based marketing offer service which operates the marketing offer server 130 may outsource some functionality, such as registration of new users). Thus, a third party server may be a part of system 100.

A user device 110 may comprise a computing device associated with a user who has registered with (or has at least one of consented to receive marketing offers from or is able to receive marketing offers from) a location based marketing offer service as described herein. For example, a user device 110 may comprise at least one of (i) a personal computer (PCP) such as a desktop, laptop or tablet computer, (ii) a mobile device such as at least one of a cellular telephone, a Personal Digital Assistant (PDA) and a smartphone; (iii) a media content viewing device such as a television or set-top box; (iv) a sub-notebook (e.g. an Apple™ iPad™ device), (v) a landline or cable-enabled telephone, (vi) a one-way or two-way pager, (vii) a kiosk (e.g., a dedicated device for outputting coupons or other marketing offers), and (viii) any other appropriate storage and/or communication device. A user device 110 may be operable, in accordance with some embodiments, to communicate with the at least one of the marketing offer server 130 and the merchant server 120. For example, a user device 110 may be operable to communicate with a marketing offer server 130 to (i) facilitate a log in of an associated user to a website or online portal of the marketing offer server 130; (ii) facilitate the user in registering with the services offered by the marketing offer server 130; (iii) provide location characteristic information to the marketing offer server 130; (iv) downloading a software application from the marketing offer server 130; (iv) facilitate the user providing permission or consent for the marketing offer server 130 to make changes to a configuration or program of the user device 110; and/or (v) receive marketing offer information for output via an output (e.g., display) device of the user device 110. A user device 110 may also be operable, in accordance with some embodiments, to communicate with a merchant server 120 to, for example, request a redemption of a coupon accepted or obtained online. In accordance with some embodiments, a user device 110 may comprise a browser that is configured in accordance with information received from a marketing offer server 130.

A merchant server 120 may comprise one or more computing devices, working in parallel or series if more than one, operable to provide information to a marketing offer server 130. For example, a merchant server 120 may provide information regarding one or more marketing offers to be output to qualifying users (e.g., including rules for outputting a respective marketing offers, such as at least one location characteristic to be associated with a user to whom the marketing offer is output). In another example, the merchant server 120 may provide information regarding one or more marketing offers output by the marketing offer server 130 which have been redeemed by a user (or which a user has attempted to redeem) at a location (e.g., a brick-and-mortar location) associated with the merchant server 120. In accordance with some embodiments, a merchant server 120 may comprise a server hosting a website for or on behalf of a particular entity (e.g., a merchant who operates one or more brick-and-mortar retail establishments and/or retail websites), which entity is desirous of sponsoring or outputting marketing offers to users who meet certain criteria (e.g., certain location characteristic criteria and certain online activity criteria).

A marketing offer server 130 may comprise one or more computing devices, working in parallel or series if more than one, operable to facilitate the determination of an appropriate marketing offer to output to a user and to facilitate the output of such an offer to the user via a user device 110. The marketing offer server 130 may be operated by or on behalf of an entity which offers services to facilitate the output (and, in some embodiments, the redemption) of marketing offers to users based on respective online activities and location characteristics of the users, in accordance with embodiments described herein. In accordance with some embodiments, a marketing offer server 130 may comprise a server hosting a website for or on behalf of such an entity. As described herein, the marketing offer server 130 may be operable, in accordance with some embodiments, to (i) communicate with a user device 110 (e.g., receive login credentials from the user device, receive an indication of a location characteristic of a user from a user or user device, facilitate the download of a software application to the user device, transmit data defining a digital coupon, etc.); and/or (ii) communicate with a merchant server 120 (e.g., receive marketing offer data from the merchant server, transmit an indication of marketing offers output to and/or accepted by users, receive information related to a redemption or attempted redemption of a marketing offer by a user, etc.).

It should be noted that whenever information is described as being “transmitted” to a device of system 100, it is intended to encompass both a “push” embodiment in which the information is pro-actively pushed or output to the device by another device and a “pull” embodiment in which the device contacts another device in order to query for any updated information or changes in information.

It should be understood that while in some embodiments any of the components 110, 120 may transmit information or communications to one another via the marketing offer server 130, in some embodiments some or all of the components 110 and 120 may communicate with one another directly or indirectly, via a wired or wireless medium such as the Internet, LAN, WAN or Ethernet, Token Ring, or via any appropriate communications means or combination of communications means. For example, in one embodiment communication among any and all of the devices of system 100 may occur over the Internet through a Web site maintained by computer on a remote server or over an on-line data network including commercial on-line service providers, bulletin board systems and the like. In some embodiments, communication among any of the components of system 100 may occur over radio signals, cellular networks, cable network, satellite links and the like. In some embodiments, output of marketing offers to users via user devices may be facilitated by a downloadable software application which allows user devices to receive and/or transmit information (e.g., location characteristic information and/or online activity information, such as key word searches performed or websites or products viewed online) to at least one of a merchant server 120 and a marketing offer server 130.

The system 100 may be operable to facilitate communication using known communication protocols. Possible communication protocols that may be useful in the system 100 include, but are not limited to: Ethernet (or IEEE 802.3), ATP, BLUETOOTH, SMPP Protocol (e.g., SMPP Protocol Version 3.4), HTTP, HTTPS, and Transmission Control Protocol/Internet Protocol (TCP/IP). Communications may be encrypted to ensure privacy and prevent fraud in any of a variety of ways well known in the art, some of which are described herein.

It should be understood that any or all of the devices of system 100 may in some embodiments comprise one or more of (i) an input device; (ii) an output device; (iii) an input/output device; or (iv) a combination thereof.

An input device, as the term is used herein, may be any device, element or component (or combination thereof) that is capable of receiving an input (e.g., from a user or another device). An input device may communicate with or be part of another device. Some examples of input devices include: a bar-code scanner, a magnetic stripe reader, a computer keyboard or keypad, a button (e.g., mechanical, electromechanical or “soft”, as in a portion of a touch-screen), a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port, and a weight scale.

An output device may comprise any device, component or element (or a combination thereof) operable to output information from any of the devices described herein. Examples of an output device include, but are not limited to, a display (e.g., in the form of a touch screen), an audio speaker, an infra-red transmitter, a radio transmitter, an electric motor, a dispenser, an infra-red port, a Braille computer monitor, and a coin or bill dispenser.

An input/output device may comprise components capable of facilitating both input and output functions. In one example, a touch-sensitive display screen comprises an input/output device (e.g., the device outputs graphics and receives selections from an authorized person).

It should be understood that although only one user device 110 is illustrated, any number of user devices 110 may be included and, in many embodiments, a large number of each such device would be part of system 100, the number changing as users are added/registered with the system and/or discontinue using the system.

According to one illustrative and non-limiting example embodiment, a user employs a user device 110 to communicate with marketing offer server 130 in order to exchange coupon information. For example, a user may use his or her PC to access a website operated by or on behalf of marketing offer server 130. The user may then enter text information, such as by using a keyboard and mouse coupled to the PC, to provide this information (directly or indirectly) to server computer 130. For example, a user may use a keyboard to enter search terms into a search engine (e.g., Google™, Yahoo!™ or Bing™), which search terms are also transmitted to marketing offer server 130 (e.g., via a software application previously downloaded by the user to the user device 110). The marketing offer server 130, having previously received marketing offers from various merchants via respective merchant servers 120, determines which (if any) marketing offer to output to the user via a display of the user device 110 based on a location characteristic of the user (which may also be transmitted to the marketing offer server 130 at the time of the user's online search or at a previous time) and the online activity (in the present example, the key word search conducted via the search engine). The marketing offer server 130 may then cause the user device 110 to output an appropriate marketing offer based on the location characteristic and the online activity of the user. In accordance with one embodiment, a plurality of marketing offers are determined by marketing offer server 130 to be appropriate for output to the user and are output as ranked coupon offers (e.g., the coupons ranked the highest are output at the top or beginning of a list). Various factors may cause a coupon or other marketing offer to be ranked higher or lower on a particular list or output and are described in detail elsewhere herein.

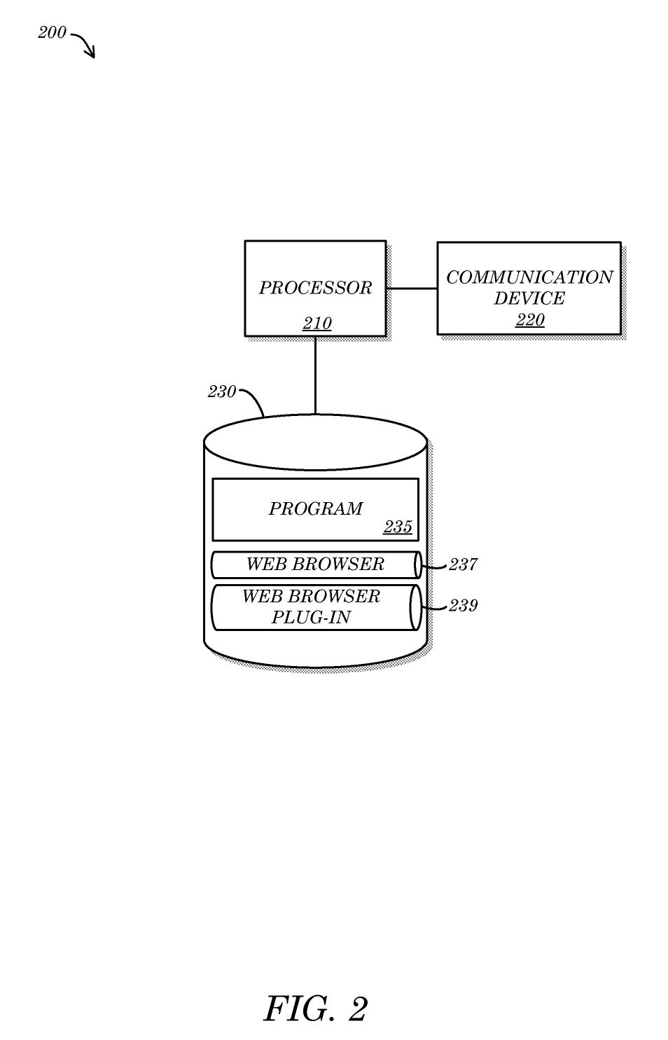

Referring now to FIG. 2, illustrated therein is a block diagram of a user device 200 (which is one embodiment of a user device 110 of FIG. 1). User device 200 comprises a processor 210, such as one or more INTEL® Pentium® processors, operatively coupled to a communications device 220. Communication device 220 comprises a component (e.g., a port or other type of device, which can be embodied as hardware, software and/or firmware) for communicating, directly or indirectly, with one or more other devices, such as one or more marketing offer servers 130 and/or one or more merchant servers 120. For example, a communication device 220 provides the user device 200 the capability of transmitting an indication of a location characteristic (e.g., an IP address of a user device) of a user and/or receive data comprising a coupon (or other marketing offer information) from a marketing offer server 130. The communication device 220 may be operable to work in various language and protocol environments, as would be understood by one of ordinary skill in the art (e.g., http, TCP/IP, SMPP). The communication device 220 may comprise, for example, an Ethernet port, a PTSN port, a wireless modem, a wireless network card, a SIM card, a USB port or a serial port. It should be understood that user device 200 may comprise more than one communication device 220.

The processor 210 is also in communication with a storage device 230. The storage device 230 may comprise any appropriate information storage device, including combinations of magnetic storage devices (e.g., magnetic tape and hard disk drives), optical storage devices, and/or semiconductor memory devices such as Flash Memory, Random Access Memory (RAM) devices, and Read Only Memory (ROM) devices.

The storage device 230 stores a program 235 for controlling the processor 210. The processor 210 performs instructions of the program 235, and thereby operates in accordance with embodiments of the present disclosure. For example, the processor 210 may arrange for IP address data, web addresses, search terms, and selection data (such as whether or not a user has clicked on a coupon) to be received from and/or transmitted to a marketing offer server 130. As illustrated in the example of FIG. 2, in accordance with some embodiments the storage device 230 also stores a web browser 237 and a web browser plug-in 239, for use in some embodiments as described elsewhere herein. In accordance with some embodiments, the web browser plug-in 239 may be downloaded to a user device (e.g., at the instruction, authorization or request of a user) from a marketing offer server 130. In accordance with some embodiments, the web browser plug-in 239 may be initiated or launches each time the web browser 237 is opened or launched or upon a separate input from a user. In accordance with some embodiments, the web browser plug-in 239 may be operable to output one or more marketing offers to a user at the instruction of the marketing offer server 130.

The term “IP address” as it is used herein unless indicated otherwise, refers to an Internet Protocol address (IP address) consisting of a numerical designation or code assigned to each device (e.g., computer, printer) participating in a computer network that uses the Internet Protocol for communication. An IP address may be utilized, for example, for purposes of host or network interface identification and location addressing. In accordance with Internet Protocol Version 4 (IPv4), which is still in use today, an IP address is a 32-bit number. However, a new addressing system (IPv6), using 128 bits for the address, was developed in 1995, standardized as RFC 2460 in 1998, and its deployment has been ongoing since the mid-2000s. An IP addresses may be stored in text files and displayed in human-readable notations, such as 172.16.254.1 (for IPv4), and 2001:db8:0:1234:0:567:8:1 (for IPv6). The Internet Assigned Numbers Authority (IRNA) manages the IP address space allocations globally and delegates five regional Internet registries (RIRs) to allocate IP address blocks to local Internet registries (Internet service providers) and other entities. In various embodiments described herein, an IP address of a user device is used to determine a location characteristic of a user or the user device.

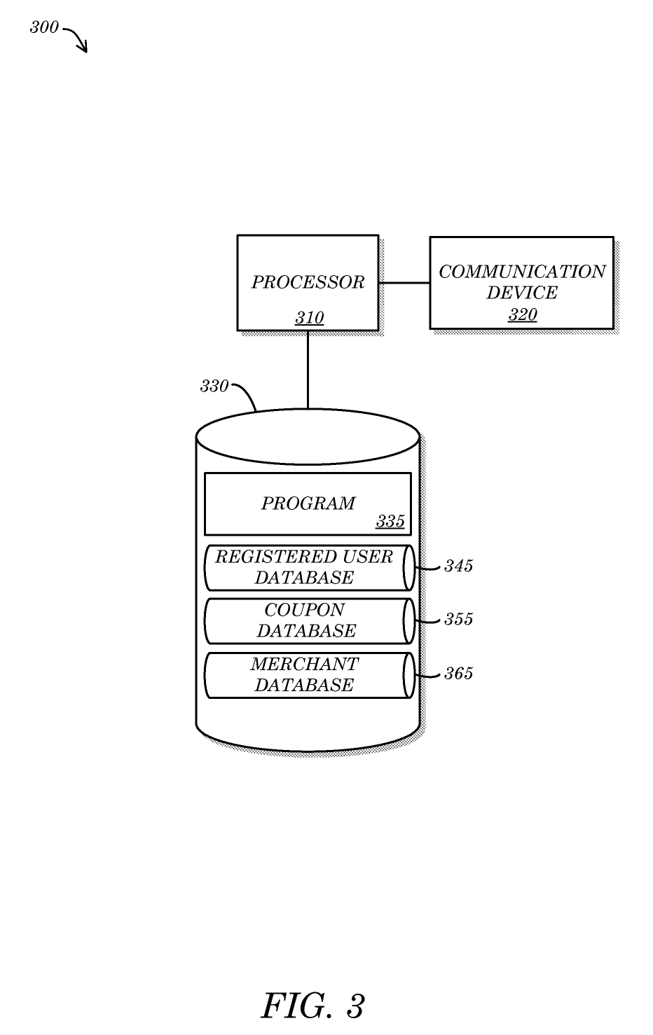

Referring now to FIG. 3, illustrated therein is a block diagram of a marketing offer server 300 (which may be one embodiment of a marketing offer server 130 of FIG. 1). The marketing offer server 300 may be implemented as a system controller, a dedicated hardware circuit, an appropriately programmed general-purpose computer, or any other equivalent electronic, mechanical or electro-mechanical device. The marketing offer server 300 may comprise, for example, one or more server computers operable to communicate with (a) one or more user devices (FIG. 1); (b) one or more merchant servers 120 (FIG. 1) and/or (c) one or more additional devices (e.g., gateway server, router devices or other devices for facilitating the receipt, determination, selection, output, storage or management of a marketing offer to a user based on the user's location characteristic(s) and online activity). The marketing offer server 300 may be operable to facilitate some functions or procedures described herein, such as registering one or more user devices and/or users, tracking a user's online activity, determining a user's location characteristic(s), selecting one or more marketing offers for output to a particular user (e.g., based on information received from a merchant participating in the location based marketing offer service facilitated by the marketing offer server 300) and/or facilitating the redemption of a marketing offer. The marketing offer server 300, as well as other devices described herein (such as a user device 110 and/or a merchant server 120), including components thereof, may be implemented in terms of hardware, software or a combination of hardware and software.

The marketing offer server 300 comprises a processor 310, such as one or more INTEL PENTIUM processors. The processor 310 is in communication with a communication device 320. Communication device 320 comprises a component (e.g., a port or other type of device, which can be embodied as hardware, software and/or firmware) for communicating, directly or indirectly, with one or more other devices, such as one or more user devices 110 and/or one or more merchant servers 120. For example, a communication device 320 provides the marketing offer server 300 the capability of receiving an indication of a location characteristic (e.g., an IP address of a user device) of a user and/or coupon (or other marketing offer information) from a merchant server 120. The communication device 320 may be operable to work in various language and protocol environments, as would be understood by one of ordinary skill in the art (e.g., http, TCP/IP, SMPP). The communication device 320 may comprise, for example, an Ethernet port, a PTSN port, a wireless modem, a wireless network card, a SIM card, a USB port or a serial port. It should be understood that marketing offer server 300 may comprise more than one communication device 320.

The processor 310 is further in communication with a memory 330. The memory 330 may comprise an appropriate combination of magnetic, optical and/or semiconductor memory, and may include, for example, Random Access Memory (RAM), Read-Only Memory (ROM), a compact disc and/or a hard disk. The processor 310 and the memory 330 may each be, for example: (i) located entirely within a single computer or other device; or (ii) connected to each other by a remote communication medium, such as a serial port cable, telephone line or radio frequency transceiver. In one embodiment, the marketing offer server 300 may comprise one or more devices that are connected to a remote server computer for maintaining databases.

Memory 330 stores at least one program 335 (which may be embodied as a plurality of software modules) for directing the processor 310 to perform certain functions. The processor 310 performs instructions of the program 335, and thereby operates in accordance with at least some of the methods described in detail herein. The program 335 may be stored in a compressed, uncompiled and/or encrypted format. The program 335 may include program elements that may be necessary, such as an operating system, a database management system and “device drivers” for allowing the processor 310 to interface with computer peripheral devices. Appropriate program elements are known to those skilled in the art, and need not be described in detail herein.

Some example software module(s) that may be stored in memory 330 (e.g., comprise program 335) include, without limitation: (i) a general program, which may include instructions for operating the marketing offer server 300; (ii) a Registration Application, which may include instructions for a process to register a user device and/or user with the services of marketing offer server 300; (iii) a download application, which may include instructions for downloading a web browser plug-in to a user device in accordance with embodiments described herein; (iv) a user online activity tracking application, which may include instructions for determining or tracking online activity of a user (e.g., via a web browser plug in on a user's user device, such as the key words entered by the user into a search engine, or a URL address of a web page viewed by a user on a user device) and (iv) a coupon selection application, which may include instructions for determining whether the user's online activity and location characteristic qualifies the user to receive an output of one or more coupons (or other marketing offers) from participating merchants. Each of these example software modules is described in more detail below, via a description of flow diagrams relevant to functions which may be performed by the marketing offer server 300.

Any of the software module(s) described herein as possibly being components of program 335 may be part of a single program or integrated into various programs for controlling processor 310. Further, the program 335 may be stored in a compressed, uncompiled and/or encrypted format and include instructions which, when performed by the processor 310, cause the processor 310 to operate in accordance with at least some of the methods described herein. Of course, additional or different software module(s) or applications may be included in program 335 and it should be understood that the example software module(s) 335 described herein are not necessary in any embodiments.

According to an embodiment, the instructions of the program 335 may be read into a main memory from another computer-readable medium, such from a ROM to RAM. Execution of sequences of the instructions in the program 335 may cause processor 310 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

The memory 330 further stores a registered user database 345, which stores information about user devices and/or users registered with the marketing offer 300 or to which the marketing offer server is otherwise operable to output marketing offers (e.g., registration with the marketing offer server 300 by participating users is not necessary or required in all embodiments). Such information may include, for example, (i) contact information for the user and/or user device (e.g., e-mail or IP address); (ii) one or more location characteristic(s) of a user (e.g., home address, work address, commuting route) and/or user device (e.g., IP address, GPS-determined current location); (iii) an indication of marketing offers output, accepted and/or redeemed; and (iv) login credentials (e.g., username and password).

The memory 330 further stores a coupon database 355, which stores information about one or more coupons (or other marketing offers) available for output to participating users. For example, for each coupon stored in the coupon database 355, the following information may be defined: (i) an associated merchant; (ii) one or more rules for outputting the coupon (e.g., a location characteristic and qualifying online activity); (iii) a product or service that is the subject of the coupon; and (iv) an indication of a value of the coupon.

The memory 330 further stores a merchant database 365, which stores information about the merchants who participate in the services offered by the marketing offer server 300. Such information may include, for example, information identifying merchants who have provided coupons (or other marketing offers) for output by the marketing offer server 300, an identifier of each such coupon (or other marketing offer), an address for one or more brick-and-mortar retail establishment locations of each such merchant, contact information for each such merchant, passwords or other encryption information for communicating securely with the merchants and/or other information (e.g., financial or account information).

Although the databases 345 through 365 are described as being stored in a memory of marketing offer server 300, in other embodiments some or all of these databases may be partially or wholly stored, in lieu of or in addition to being stored in a memory of marketing offer server 300 and/or in a memory of one or more other devices. Such one or more other devices may comprise, for example, another computing device with which marketing offer server 300 is operable to communicate. Further, some or all of the data described as being stored in the memory 330 may be partially or wholly stored (in addition to or in lieu of being stored in the memory 330) in a memory of one or more other devices. Such one or more other devices may comprise, for example, a remote storage service server (e.g., an online back-up storage server, as would be understood by one of ordinary skill in the art).

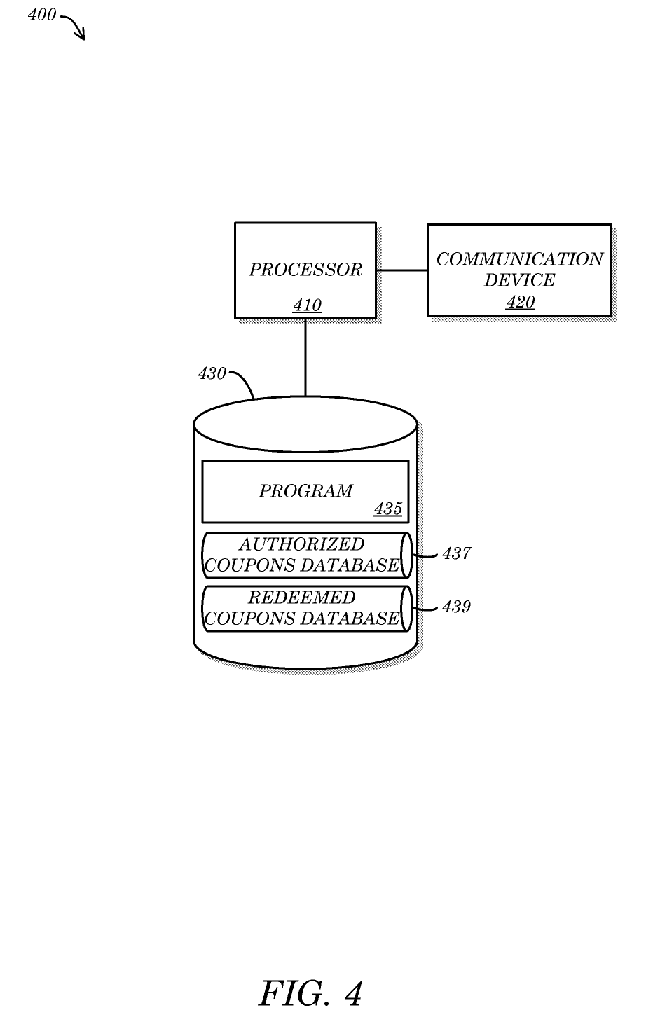

Referring now to FIG. 4, illustrated therein is a block diagram of a merchant server 400 (which may be one embodiment of a merchant server 120 of FIG. 1). The merchant server 400 may be implemented as a system controller, a dedicated hardware circuit, an appropriately programmed general-purpose computer, or any other equivalent electronic, mechanical or electro-mechanical device. The merchant server 400 may comprise, for example, one or more server computers operable to communicate with (a) one or more user devices (FIG. 1); (b) one or more marketing offer servers 130 (FIG. 1) and/or (c) one or more additional devices (e.g., gateway server, router devices or other devices for facilitating the authorization, redemption or management of coupons (or other types of marketing offers) for provision to the marketing offer server 130. The merchant server 400 may be operable to facilitate some functions or procedures described herein, such as authorizing a coupon (or other type of marketing offer) for output to users via the marketing offer server 130 (and, in some embodiments, providing to the marketing offer server corresponding data defining an authorized coupon and the attendant rules for output of such authorized coupon) and/or facilitating the redemption of a coupon or other type of marketing offer. The merchant server 400, including components thereof, may be implemented in terms of hardware, software or a combination of hardware and software.

The merchant server 400 comprises a processor 410, such as one or more INTEL PENTIUM processors. The processor 410 is in communication with a communication device 420. Communication device 420 comprises a component (e.g., a port or other type of device, which can be embodied as hardware, software and/or firmware) for communicating, directly or indirectly, with one or more other devices, such as one or more user devices 110 and/or one or more marketing offer servers 130. For example, a communication device 420 provides the merchant server 400 the capability of transmitting (e.g., to the marketing offer server) data defining one or more coupons (or other marketing offers) to be output to users by the marketing offer server based on rules provided by the merchant server 400 (e.g., based on a qualifying location characteristic and online activity corresponding to output of a particular coupon). The communication device 420 may be operable to work in various language and protocol environments, as would be understood by one of ordinary skill in the art (e.g., http, TCP/IP, SMPP). The communication device 420 may comprise, for example, an Ethernet port, a PTSN port, a wireless modem, a wireless network card, a SIM card, a USB port or a serial port. It should be understood that merchant server 400 may comprise more than one communication device 420.

The processor 410 is further in communication with a memory 430. The memory 430 may comprise an appropriate combination of magnetic, optical and/or semiconductor memory, and may include, for example, Random Access Memory (RAM), Read-Only Memory (ROM), a compact disc and/or a hard disk. The processor 410 and the memory 430 may each be, for example: (i) located entirely within a single computer or other device; or (ii) connected to each other by a remote communication medium, such as a serial port cable, telephone line or radio frequency transceiver. In one embodiment, the merchant server 400 may comprise one or more devices that are connected to a remote server computer for maintaining databases.

Memory 430 stores at least one program 435 (which may be embodied as a plurality of software modules) for directing the processor 410 to perform certain functions. The processor 410 performs instructions of the program 435, and thereby operates in accordance with at least some of the methods described in detail herein. The program 435 may be stored in a compressed, uncompiled and/or encrypted format. The program 435 may include program elements that may be necessary, such as an operating system, a database management system and “device drivers” for allowing the processor 410 to interface with computer peripheral devices. Appropriate program elements are known to those skilled in the art, and need not be described in detail herein.

Some example software module(s) that may be stored in memory 430 (e.g., comprise program 435) include, without limitation: (i) a general program, which may include instructions for operating the merchant server 400; (ii) an authorized marketing offer application, which may include instructions for transmitting to a marketing offer server 130 an indication of one or more marketing offers (and any attendant rules for characteristic(s) of users which must be satisfied prior to the output of a respective marketing offer to a user) and instructions for storing an indication of the one or more marketing offers so authorized and transmitted; and (iii) a redemption application, which may include instructions for authorizing a redemption of a marketing offer a user is attempting to redeem at a retail location (e.g., a brick-and-mortar) location of the merchant operating merchant server 400 (or for storing an indication of marketing offers so redeemed). Each of these example software modules is described in more detail below, via a description of flow diagrams relevant to functions which may be performed by the merchant server 400.

Any of the software module(s) described herein as possibly being components of program 435 may be part of a single program or integrated into various programs for controlling processor 410. Further, the program 435 may be stored in a compressed, uncompiled and/or encrypted format and include instructions which, when performed by the processor 410, cause the processor 410 to operate in accordance with at least some of the methods described herein. Of course, additional or different software module(s) or applications may be included in program 435 and it should be understood that the example software module(s) 435 described herein are not necessary in any embodiments.

According to an embodiment, the instructions of the program 435 may be read into a main memory from another computer-readable medium, such from a ROM to RAM. Execution of sequences of the instructions in the program 435 may cause processor 410 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

The memory 430 further stores an authorized coupon database 437, which stores information about marketing offers authorized for output by a marketing offer server 130. Such information may include, for example, for each respective marketing offer (i) one or more location characteristic(s) of a user (e.g., home address, work address, commuting route) and/or user device (e.g., IP address, GPS-determined current location) which must be satisfied prior to the output of the attendant marketing offer; and (iii) an indication of online activity (e.g., key words entered for a search being conducted via a search engine or products or services being viewed or searched for, such as web pages or URLs being viewed via a user device) which must be satisfied prior to the output of the attendant marketing offer.

The memory 430 further stores a redeemed coupon database 439, which stores information about one or more coupons (or other marketing offers) which were output by the marketing offer server 130 and subsequently redeemed by a user. For example, for each coupon stored in the redeemed coupon database 439, the following information may be defined: (i) a date/time at which the marketing offer was output (e.g., as received from the marketing offer server 130 or indicated in an embodiment of the marketing offer); (ii) a date/time at which the marketing offer was presented for redemption; and (iii) a payment (if any) due to the marketing offer server 130 in exchange for the output (and, in some embodiments, redemption) of the marketing offer.

Although the databases 437 and 439 are described as being stored in a memory of merchant server 400, in other embodiments some or all of these databases may be partially or wholly stored, in lieu of or in addition to being stored in a memory of merchant server 400 and/or in a memory of one or more other devices. Such one or more other devices may comprise, for example, another computing device with which merchant server 400 is operable to communicate. Further, some or all of the data described as being stored in the memory 430 may be partially or wholly stored (in addition to or in lieu of being stored in the memory 430) in a memory of one or more other devices. Such one or more other devices may comprise, for example, a remote storage service server (e.g., an online back-up storage server, as would be understood by one of ordinary skill in the art).

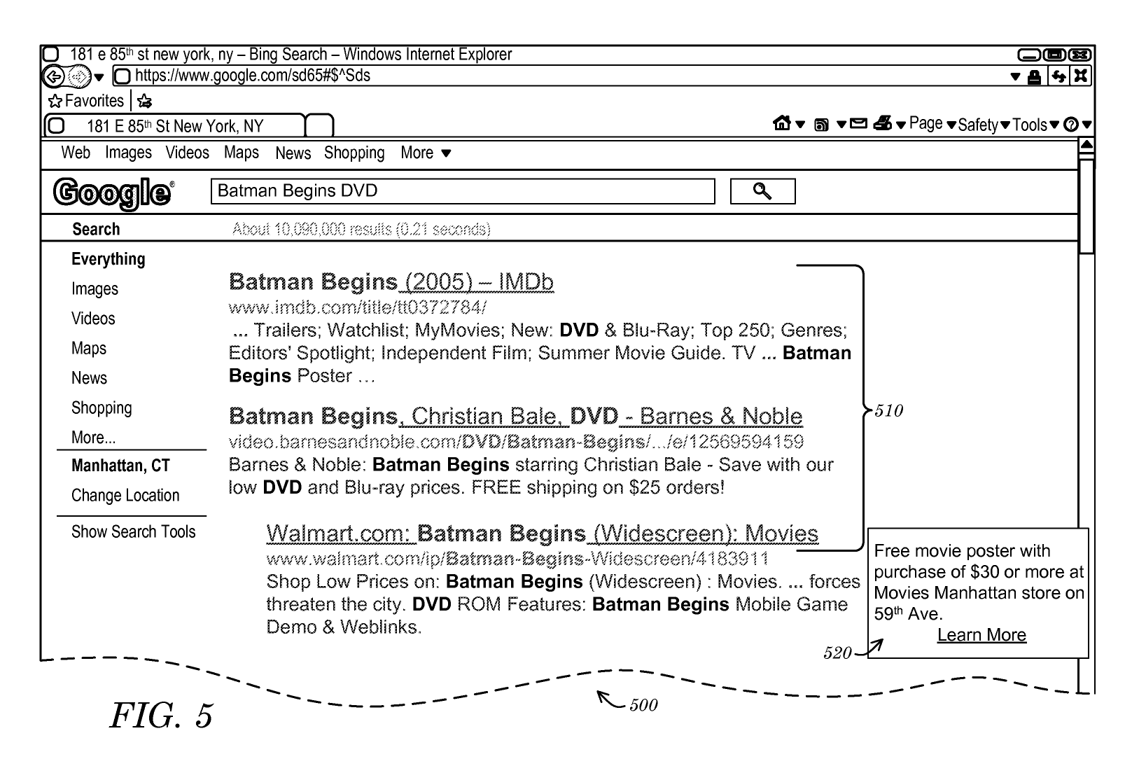

Referring now to FIG. 5, illustrated therein is a user interface 500 comprising a screen shot of one embodiment in which a user is presented with an output of a plurality of coupons based on a location characteristic and online activity of the user. For example, the user may be presented with the user interface 500 while using a search engine to enter one or more search terms into a web browser of user device 200. In the particular embodiment of FIG. 5, the user interface 500 comprises two distinct areas 510 and 520. Area 510 is for outputting to the user search results determined by the search engine based on the search terms entered by the user. Area 520 is for outputting one or more coupons (or other types of marketing offers) to the user. Area 520 may be output or generated, for example, based on web browser plug-in previously downloaded by the user to the user device and launched along with the web browser by the user. In the particular embodiment illustrated in FIG. 5, information regarding a single marketing offer or coupon is being output to the user in area 520 (and the user may select the hyperlink “learn more” to pull up additional information, such as a downloadable or printable coupon or bar code for use in redeeming the coupon). In other embodiments, a plurality of coupons or marketing offers may be output to a user at the same time (e.g., if the online activity and location characteristic(s) of the user qualify the user for more than one coupon or other type of marketing offer). In such embodiments, the plurality of coupons or other types of marketing offers may be ranked based on one or more factors. For example, in one embodiment the marketing offer server 130 (or the user device, via a locally stored software application) may be programmed to determine an order in which the plurality of coupons are to be output (e.g., which is to be output first or at a top of a list, which is to be output next, etc.) based on one or more factors such as (i) proximity of the merchant location of the coupon to the location characteristic of the user; (ii) a payment amount (if any) to be received by the marketing offer server 130 from an associated merchant in exchange for output of the offer; (iii) relevancy of the coupon to the online activity of the user; and (iv) redemption history of coupons previously output to the user.

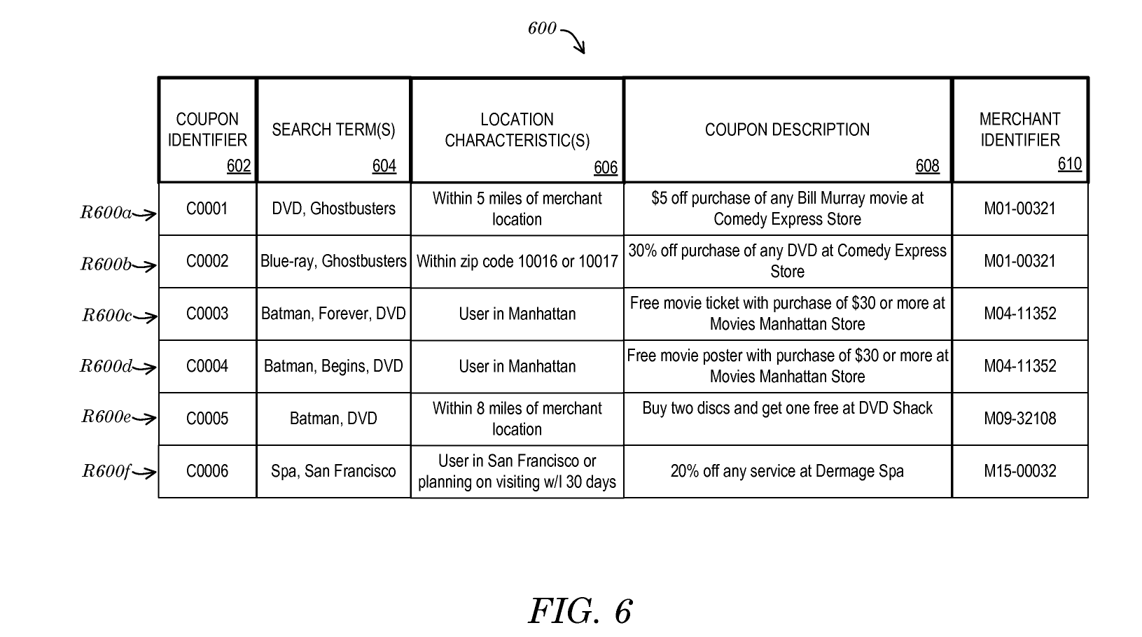

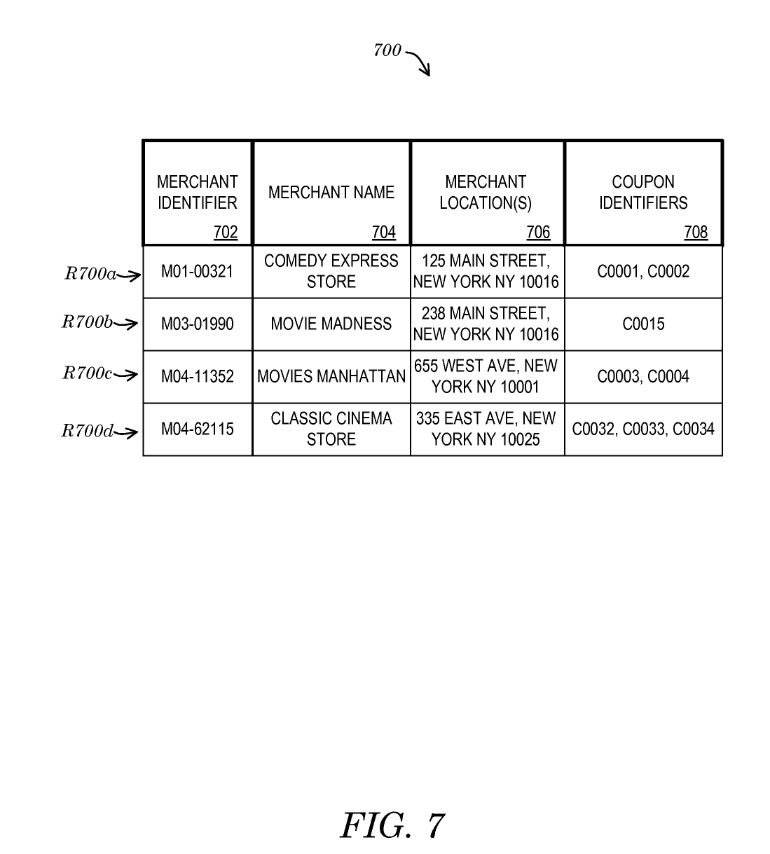

Referring now to FIG. 6 and FIG. 7, illustrated therein are respective example structures and sample contents of some databases which may be useful in some embodiments. The specific data and fields illustrated in FIGS. 6 and 7 represent only some embodiments of the records that may be stored in such databases. The data and fields of such a databases can be readily modified, for example, to include different, more or fewer data fields and/or contents to be stored therein. A single database that is a combination of multiple databases, or a configuration that utilizes multiple databases for a single database illustrated herein may also be employed. Note that in the databases of FIGS. 6 and 7, a different reference numeral is employed to identify each field. However, in at least one embodiment, fields that are similarly named (e.g., an offer identifier) may store similar or the same data in a similar or in the same data format.

As will be understood by those skilled in the art, the schematic illustration and accompanying descriptions of data contained in the sample databases presented herein is an exemplary arrangement for stored representations of information. Any number of other arrangements may be employed besides those suggested by the tables shown. For example, the embodiments described herein could be practiced effectively using more functionally equivalent databases. Similarly, the illustrated entries of the databases represent exemplary information only; those skilled in the art will understand that the number and content of the entries can be different from those illustrated herein. Further, despite the depiction of the databases as two distinct tables, a relational database model employing multiple related tables or an object-based model could be used to store and manipulate the data types of one or more embodiments. Likewise, object methods or behaviors can be used to implement the processes of one or more embodiments.

Turning now to FIG. 6 in particular, illustrated therein is a tabular representation 600 of an example embodiment of coupon database 355 (e.g., as it may be stored in a memory of a marketing offer server 300 and/or in a memory of another device). Tabular representation 600 is referred to herein as coupon database 600. It should be noted that although the coupon database 600 and attendant description thereof refers to “coupons”, similar data may be stored for other types of marketing offers in some embodiments and the term “coupon” may be interchanged with “marketing offer” in some embodiments.

The coupon database 600 includes a number of records R600a through R600f, each defining a coupon available for output to a user from marketing offer server 300 (e.g., via a web browser plug-in downloaded to a user device of the user from a website associated with the marketing offer server 300). A plurality of fields stores data for each such record. The fields specify: (i) a coupon identifier 602, which uniquely identifies a coupon available for output to a user; (ii) one or more search terms 604 which serves as a pre-requisite for output of the corresponding coupon in accordance with some embodiments; (iii) a location characteristic 606 which serves as another pre-requisite for output of the corresponding coupon in accordance with some embodiments; (iv) a coupon description 608 which comprises a description of the offer comprising the corresponding coupon; and (v) a merchant identifier 610, which uniquely identifies the merchant who provided or authorized the corresponding coupon for output via the marketing offer server 300.

The information stored in coupon database 600 may be retrieved and/or modified by a device of system 100 (FIG. 1) in accordance with some embodiments. For example, the information in the coupon database 600 may be continually updated with information received from a merchant server 120 (e.g., a merchant corresponding to a particular coupon, as identified in field 610, may modify one or more pre-requisites for output of the corresponding coupon, such as the search term(s) which may trigger the output of the coupon).

In accordance with one embodiment, the coupon identifier 602 serves to uniquely identify a particular coupon. The coupon identifier 602 may be generated, for example, by the marketing offer server 130 for each new coupon (and associated information) entered into the system (e.g., based on a request, authorization or data received from a participating merchant).

In accordance with one embodiment, the one or more search term(s) 604 may indicate what search term(s), when entered by a user into a web browser (or search engine) may qualify the user for output of the corresponding coupon. In accordance with some embodiments, input of particular search term(s) comprises online activity which may qualify a user for output of a particular coupon or other type of marketing offer. Of course, other types of online activities may qualify a user for output of a marketing offer in some embodiments and indications of such other types of online activities may be stored in coupon database 600 in such embodiments (e.g., a browser of a user device accessing a specified online merchant's website, accessing information about a specified product or service, accessing a particular URL, etc.).

As described herein, a location characteristic of a user or user device may be another pre-requisite or condition which must be satisfied (e.g., along with specified online activity) in order for an associated user to qualify for output of a particular coupon. Accordingly, the location characteristic 706 specifies the location characteristic which, when satisfied by a characteristic or data of a user or user device, may qualify the user for output of the corresponding coupon.

It should be noted that, in accordance with some embodiments, a location characteristic may comprise an IP address of a user device. The IP address may be correlated to a particular geographical location (e.g., zip code, region, city/state, etc.). In some embodiments, an IP address is determined for a user device (e.g., by marketing server 130 via a web-browser plug-in of the user device or otherwise) and the geographical location of the user device (which may be presumed to be the geographical location of the associated user) may first be determined. This geographical location may then be utilized to determine, based on the location characteristic(s) of the respective coupons stored in coupon database 600, whether the associated user qualifies for output of the corresponding coupon. Thus, in some embodiments, a location characteristic as it is received or determined initially from a user device may be translated into a different format or type of location information, if the information location format as stored in the coupon database 600 does not directly correspond to the format of the location information as it is received or otherwise determined from a user device. In other embodiments, the location characteristic stored in field 706 may be in the form of an IP address or other format (e.g., GPS coordinates) as it is received or determined from a user device and no additional step of translating the IP address or GPS coordinates into a format stored in the database may be necessary.

The coupon description 608 may comprise a description of the offer comprising the coupon. The description may comprise, for example, a text or graphical description of the coupon. In some embodiments, the description may comprise graphics or other specifications (e.g., font specifications) which may be used in outputting an indication of the coupon to a user device. In some embodiments, the coupon description field 608 or another field may comprise a pointer to another table or database which stores data to be output to a user if the user qualifies to receive the corresponding coupon.

The merchant identifier 610 stores a unique identifier of a merchant (or, for example, a particular merchant location) associated with the corresponding coupon. Of course, in some embodiments, the merchant identifier may be incorporated into the coupon identifier such that two distinct fields for such data are not necessary. Of course, additional information regarding a coupon defined in the coupon database 600 may be stored. For example, an expiration date for a coupon, a maximum number of times a coupon may be output (or accepted) and/or data usable for ranking the coupon (e.g., in a scenario in which a user's online activity and location characteristic(s) qualifies him for a plurality of coupons) may be stored.

For example, record R600e defines a coupon “C0005” which is to be output to a user who inputs the search terms “Batman” and “DVD” and who is determined to be “within 8 miles of merchant location” (in some embodiments, the address (whether street address or URL of the particular merchant location may be further specified). The coupon “C0005” comprises an offer of “Buy two discs and get one free at DVD Shack” In the present illustrative and non-limiting example, the “DVD Shack” defined in the coupon description may comprise the merchant location at which the coupon may be redeemed, in accordance with some embodiments, and may be further identified with a particular address of such merchant location.

Referring now to FIG. 7, illustrated therein is a tabular representation 700 of an example embodiment of a merchant database 365 (e.g., as it may be stored in a memory of a marketing offer server 300 and/or in a memory of another device). Tabular representation 700 is referred to herein as merchant database 700. The merchant database 700 includes a number of records R700a through R700fd, each defining a merchant (which may comprise a brick-and-mortar merchant, an online merchant or a merchant which operates both online website(s) and brick-and-mortar location(s).

For each record, the merchant database 700 defines a plurality of fields, the fields including: (i) a merchant identifier 702, which uniquely identifies a merchant participating in the services of marketing offer server 130; (ii) a merchant name 704 (e.g., a trade name or name by which consumers identify the merchant, or another business name associated with a trade name by which consumers identify a given merchant); (iii) an indication of one or more merchant location(s) 706, which may comprise a URL or website address in the case of an online merchant location or a street address in the case of a brick-and-mortar location (in some embodiments, a distinct merchant location identifier may be associated with each merchant location); and (iv) one or more coupon identifier(s) of active coupons or other marketing offers submitted to marketing offer server 130 by the corresponding merchant, for output to users via the methods described herein.

Of course, different or additional information may be stored in association with a merchant in the merchant database 700. For example, in accordance with some embodiments, the following information may be stored for a merchant in the merchant database or another database of the marketing offer 130: (i) contact information for the merchant (e.g., an e-mail or IP address of the merchant server or an e-mail address and/or phone number for a representative of the merchant); (ii) an indication of popularity and/or success rate(s) for particular coupons of the merchant; and/or (iii) financial account information (e.g., fees due from the merchant based on coupons output on behalf of the merchant or redeemed by users, a fee schedule or payment agreement agreed to be the merchant, an amount of funds available for use in outputting coupons on behalf of the merchant, etc.).

In accordance with some embodiments, merchants may be enabled to create coupons (or other types of marketing offers) and pay for their distribution and use via electronic exchanges between a merchant server 120 of the merchant and marketing offer server 130 of the location based marketing offer service described herein. For example, a merchant may create an account with the location based marketing offer service (e.g., by establishing a merchant name and password and providing information such as one or more locations, whether brick-and-mortar or online, contact information, financial account information, etc.) In some embodiments, additional information that could be provided by the merchant includes a phone number, store hours, inventory levels, categories of product sold, credit card information for billing by the merchant, etc. A merchant who creates an account with the location based marketing offer server may then define and submit one or more coupons or other types of marketing offers for storage in coupon database 600 or another memory component of marketing offer server 130. In defining and submitting a coupon or other type of marketing offer, a merchant may provide text describing the offer and, in some embodiments, graphical images or illustrations to be used in an output of the offer. In defining the coupon or other type of marketing offer the merchant may also provide the one or more location characteristic(s) (e.g., the coupon may only be output to users who are determined to be (currently or in the future) within a predetermined distance of a location at which the coupon may be redeemed) and online activities which must be satisfied by a user prior to the corresponding coupon being output to the user. The merchant may also provide one or more specified location(s) at which the coupon may be redeemed. In creating an account with the location based marketing offer service, a merchant may also agree to a payment option for how the merchant agrees to pay the location based marketing offer service for output, management and/or storage of the coupons defined by the merchant. For example, the merchant might indicate that he wants to pay only when a coupon is actually redeemed.

In accordance with some embodiments, coupon information may be vetted in some way prior to making it available to users (e.g., prior to the coupons being made available for selection or output to users). For example, the location based marketing offer service described herein as facilitating the management and output of coupons or other types of marketing offers may employ people or software to review coupon information prior to accepting it into the system and/or storing it in a coupon database (e.g., software may be employed to search for potentially objectionable key words).

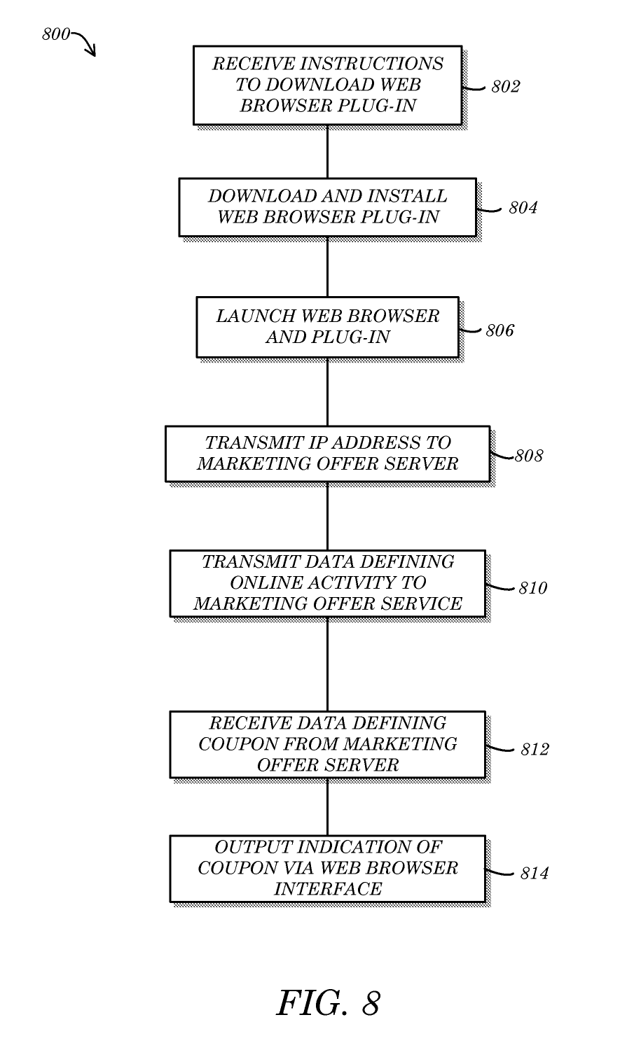

Referring now to FIG. 8, illustrated therein is a flowchart of an example process 800 consistent with some embodiments described herein. It should be noted that process 800 is exemplary only and should not be construed in a limiting fashion. For example, additional and/or substitute steps to those illustrated may be practiced within the scope of the present invention and in one or more embodiments one or more steps may be omitted or modified. Similarly, the steps may be performed in a different order from that illustrated in FIG. 8, as is reasonable and desirable. In one embodiment, the process 800 is performed by a user device 110 (FIG. 1), which may be embodied as user device 200 (FIG. 2).

As described herein, in accordance with some embodiments a marketing offer such as a coupon is output to a user via a user device if the user qualifies for output of the marketing offer based on (i) a location characteristic(s) of the user or user device; and (ii) online activity of the user. In accordance with some embodiments, qualifying online activity may comprise the user inputting qualifying key words or search terms into a search engine (e.g., via the web browser of the user device). The process 800 is directed to an embodiment in which the key words or terms a user enters into a search engine are monitored via a web browser plug-in that the user has previously downloaded to the user device (e.g., from a website operated by or on behalf of a marketing offer service as described herein). The web browser plug-in enables the marketing offer service (which operated, in accordance with some embodiments, the marketing offer server 130) to receive from the user device an indication of an IP address of the user device and the key words or terms entered into a search engine by the user. The IP address may be used to infer, for example, a location (e.g., zip code, city and state, etc.) of the user. Either the IP address or the location determined therefrom may be used as a location characteristic for determining whether the user qualifies for output of an offer.

The user device 200, in step 802, receives instructions or input from a user, the instructions or input directing the user device to download from a specified website software used in the determination, selection, output, storage and/or management of coupons or other types of marketing offers. For example, the user may cause the user device 200 to access a web page by entering (or otherwise navigating to) a particular web address, URL or IP address (e.g., that of the marketing offer server 130). For example, the user may enter the URL of a site which allows the user to download such software into the navigation bar of browser software stored on user device 200. Suitable web browsers include, without limitation, Safari™, Internet Explorer™, Chrome™, Firefox™, and Opera™. The website or server so accessed by the user device (e.g., marketing offer server 300) may output to the user device HTML code that includes links to browser plug-in modules for a variety of web browsers (e.g., the links to the one or more browser plug-in modules may be output as links on the website, with accompanying instructions for downloading such one or more browser extension or plug-in modules (also referred to herein as web browser extensions or plug-ins herein). Step 802 may further comprise, in some embodiments, transmitting data by the user device to the marketing offer server 130 (e.g., data input to the user device 200 by the associated user, for transmission to the marketing offer server). The data may comprise, for example, data which causes the user to be a registered user or member of the marketing offer services provided by the marketing offer server 130. For example, the user may set up login credentials (e.g., a username and password), contact information, a location characteristic (e.g., residence address, commuting route, intended travel plans or vacation destination and dates, locations frequently visited by the user, etc.), permission to track the GPS location of the user or user device and/or permission to utilize the IP address of the user device.

The term “plug-in” or “plugin” (as in a web browser “plug-in”) may refer, unless specified otherwise, to a software component which, when downloaded and installed onto a computing device, add specific functionality, feature(s) or capabilities to another (e.g., a more complex) software application already stored and installed on the computing device. For example, if supported by a software application, a plug-in may enable customization of the functionality of the software application. Plug-ins are commonly used in web browsers to play video, scan for viruses, and display new file types. Well-known plug-ins examples include Adobe™ Flash™ Player, QuickTime™, and Microsoft™ Silverlight™. A particular type of additional software operable to modify or add functionality to an existing software application comprising a browser is a browser extension. Such software extensions are programs that extend or modify the functionality of a web browser, or features available in a web browser, in some way. While the terms plug-in and extension may be distinct depending on the context, for many embodiments described herein they may be considered as interchangeable. Accordingly, when a browser plug-in is described herein, a person of ordinary skill in the art (upon reading the present disclosure) would understand that a browser extension may be utilized as an alternative to achieve similar results or functionality.

It should be noted that while various embodiments described herein involve utilization of a browser plug-in or browser extension to enable a marketing offer server to receive data from (e.g., an IP address, user online activity data) and transmit data to (e.g., coupon or other marketing offer data) to a user, in some embodiments the functionality for receiving and transmitting such data from and to a user device may not require or utilize a browser plug-in and the usage of a browser plug-in is not a requirement of the embodiments described herein. For example, in one alternate embodiments functionality for transmitting data between a marketing offer server 130 and a user device 110 may be built into web browser software itself (or into the operating system of user computer 200). In another alternate example, persistent browsing data may be utilized to enable such exchange of data. In accordance with some embodiments, persistent browsing data may be utilized to track or identify a particular user or user device (e.g., for use in determining an appropriate coupon to output to the user). The term “persistent browsing data” is used herein to refer to data or information that is stored on a user's browser or computing device (e.g., by a remote server such as a server of a location based marketing offer service as described herein), for use in facilitating output of location based marketing offers in accordance with various embodiments described herein. The persistent browsing data may be accessible to the user's browser or computing device and/or to a remote server. The persistent browsing data may store, for example, an identifier which identifies a record in a database, which record stores information defining online information previously output to a user. In one example, the persistent browsing data may comprise a cookie that is stored (e.g., as a text file) on a user's browser. In another example, the persistent browsing data may comprise HTML5 LocalStorage (also referred to as WebStorage), which allows web pages to store data within the client web browser (the stored data persisting even after the user navigates away from the web site and being available to remote servers).

Returning now to process 800, at 804 a web browser plug-in module 239 is downloaded to a user device 200. This may be done, for example, upon a user selecting a particular plug-in module 239 for download to the user device 200 and instructing the user device 200 to begin a download of the plug-in 239. Step 804 may further include, in some embodiments, installation of the plug-in 239 once it is downloaded to a memory (e.g., memory 230) of the user device 200 (e.g., such that it is operable to modify or add functionality to a web browser 237 stored on the user device 200). In accordance with some embodiments, such a plug-in module 239 may comprise software which allows the user device 200 (e.g., via a web browser 237) to receive data defining a coupon or other type of marketing offer from marketing offer server 130 and output such data to the user via a display or area of a user interface such as a user interface of the web browser 239. In accordance with some embodiments, such a plug-in module 239 may comprise software which causes the user device 200 to transmit data (e.g., IP address and online activity data such as key words or terms entered by the user into a web browser 237) to marketing offer server 130.

In 806, the web browser 237 and web browser plug-in 239 are launched, opened or initiated. For example, a user may open a web browser on the user device and the web-browser may automatically open or initiate upon the web browser being opened. In another example, a user may need to provide two distinct commands or inputs for initiating the web browser 237 and the web browser plug-in 239. In embodiments which do not employ a web browser plug-in 239, step 806 may simply comprise launching only the web browser 237.

In 808, the IP address of the user device is transmitted to the marketing offer server 130. As described herein, in accordance with some embodiments a user may qualify for output of one or more marketing offers based on a location characteristic of the user or user device. As also described herein, in some embodiments such a location characteristic may comprise an IP address of the user device or be determined based on the IP address of the user device (e.g., a zip code or other indicator of a geographical location of the user or user device may be determined based on the IP address of the user device). Accordingly, in some embodiments the IP address of the user may be transmitted to the marketing offer server by the user device or otherwise determined by the marketing offer server based on information from the user or user device. For example, the web browser plug-in 239 may be programmed to determine and transmit the IP address of the user device to the marketing offer server 130. In another embodiment, the IP address of the user device may be detected or determined by the marketing offer server 130 without aid of a web browser plug-in. For example, in some embodiments a user may log in to a website (e.g., using previously established login credentials) associated with the marketing offer server 130.

In some embodiments, if a user wants to receive output of marketing offers from the marketing offer server 130, the user may be invited to log into such a web site prior to initiating other online activity which will be tracked for purposes of determining whether the user qualifies for output of a marketing offer. The logging in may cause the marketing offers server to determine an IP address (or other location characteristic or data useful for determining a location characteristic of the user or user device). For example, in some embodiments location characteristic data associated with the user may be stored in a memory of the marketing offer server 130 (e.g., in a registered user database, not shown). Such information may comprise, for example, a residence or other address associated with the user, an address of a workplace of the user, a commuting route used by the user, an intended destination of the user and/or a location frequently visited by the user. Once the user logs into the website, such location characteristic(s) previously stored (e.g., as provided by the user) may be accessed and utilized, in conjunction with the online activity of the user, to determine whether the user qualifies for a marketing offer. Accordingly, in some embodiments step 808 may comprise transmitting data indicating (or useful in determining) a location characteristic of the user, whether it be an IP address or otherwise.

In 810, data defining online activity of the user is transmitted to the marketing offer server 130. For example, in one embodiment the online activity may comprise search terms the user enters into their browser via an input device (such as a keyboard). In such embodiments, step 810 may comprise transmitting an indication of the search terms. For example, the user may perform a Google search for “Batman™ Begins DVD” and the web browser 237 may, in response, output a list of web pages containing all of those three terms. The search results returned might, for example, include an Amazon.com™ product page for a two disc deluxe version of the DVD, an IMDb™ listing for the movie, a Blockbuster™ page advertising rental of the movie, a Barnes & Noble™ product page for the widescreen edition of the movie, or a Wikipedia™ page about the movie. Such a search might generate millions of results, ranked according to relevance algorithms of the search engine. FIG. 5, described above, comprises a user interface which shows how some such results from the input of these search terms may be output to a user. In step 810 of the present example, the search terms “Batman™ DVD” may be transmitted to the marketing offer server 130.

In other embodiments, online activity may comprise the viewing of information regarding certain products, services or retailers. For example, online activity may comprise visiting a particular URL or web page having associated therewith certain key words, such as product names, retailer names, event names, etc. For example, in one embodiment a user may visit a web page (via the user device 110) for a particular product, service or retailer. For example, the user may visit an Amazon.com™ page for the “Prince Fuse TI Tennis Racquet” that his friend mentioned at lunch. In such an embodiment, the web browser plug-in 239 may be operable to transmit data indicating the product, service or retailer which the user is viewing information on (e.g., as determined from information on the web page, any tags associated with the web page or in a URL of the web page). For example, each word in the title of the product or service may be transmitted to the server. In another example, all words in the first paragraph that describes the product could be transmitted. Accordingly, step 810 may comprise an indication of one or more words or other types of product, service or retailer identifiers associated with a web page visited by the user.

In step 812, data defining a coupon or other type of marketing offer is received from marketing offer server 130. For example, text and graphics for outputting the coupon may be received. In embodiments utilizing a web browser plug-in, the data defining the coupon or other type of marketing offer may be received by the user device via the web browser plug-in 239. In some embodiments, data defining a plurality of such coupons or other types of marketing offers may be received. In some embodiment in which a plurality of such coupons or other types of marketing offers is received, the data may further include a ranking or other indictor for the order in which the plurality of offers or other types of marketing offers should be output.

In step 814, the coupon or other marketing offer defined by the data received in step 812 is output to the user (e.g., via the web browser interface of the user device). For example, as illustrated in FIG. 5, an area 520 of the web browser user interface may be utilized to output the one or more coupons or other marketing offers to a user. Of course, the particular form in which the one or more coupons or other types of marketing offers are output is not limited to the embodiment illustrated in FIG. 5. There are many ways in which the coupons transmitted to a user device may be displayed and the embodiments described herein are not dependent on any particular form of output or display. Some example embodiments of outputting the coupons (or other types of marketing offers) to a user include, without limitation: (i) incorporating information about a coupon into a small bar just below the navigation bar of the browser; (ii) causing the coupon to be output in a pop-up window generated by the browser; (iii) an audio output (e.g., an audio message played to the user via a speaker of the user device); (iv) via a text messages to the user's phone or other device (even if such device is different from the device on which the user conducted the online activity which qualified the user for output of the coupon); and (v) via an email message. Alternatively, coupons may also be mailed to the user in printed form via postal mail.

In some embodiments, process 800 may comprise additional steps. For example, in one embodiment the user device (e.g., via a web browser plug-in) may transmit to the merchant server 130 an indication of what action (if any) a user undertook in response to the output of one or more coupons or other marketing offers. For example, information about which (if any) coupons the user selected (e.g., clicked on for more information), printed, saved and/or redeemed may be transmitted to the marketing offer server 130.

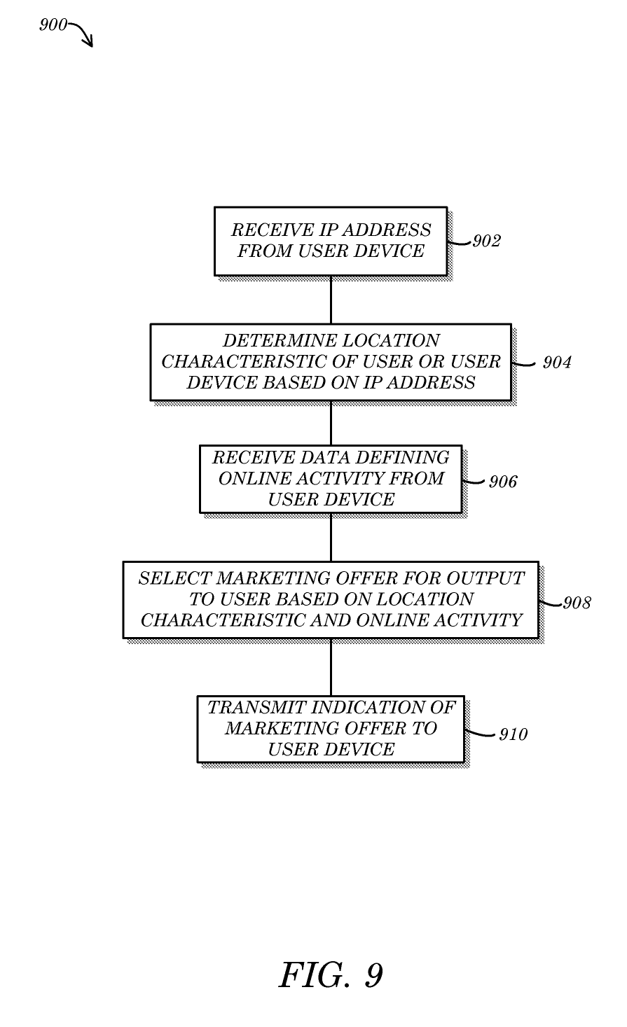

Referring now to FIG. 9, illustrated therein is a flowchart of an example process 900 which is consistent with at least some embodiments described herein. It should be noted that process 900 is exemplary only and should not be construed in a limiting fashion. For example, additional and/or substitute steps to those illustrated may be practiced within the scope of the present invention and in one or more embodiments one or more steps may be omitted or modified. Similarly, the steps may be performed in a different order from that illustrated in FIG. 9, as is reasonable and desirable. In one embodiment, the process 900 is performed by a marketing offer server 130 (FIG. 1), which may be embodied as marketing offer server 300 (FIG. 3). In accordance with some embodiments, some of the steps of process 900 are performed responsive to some of the steps of process 800 as these latter steps are performed by a user device.

In accordance with some embodiments which employ a web browser plug-in for facilitating the exchange of data between a user device 110 and a marketing offer server 130, the process 900 may be preceded by a process in which a request to download a web browser plug-in is received from a user device and such web browser plug-in is downloaded to the user device. It should be understood that the particular process by which a user obtains such a web browser plug-in is not limited to download of one or more files from a website. For example, in some embodiments a user may obtain such a web browser plug-in via one or more software files being sent to the user in the form of an e-mail or disc from which the user may transfer the files comprising the web browser plug-in to the user device.

In embodiments in which a user pre-registers with a location based marketing offer service (e.g., by providing registration information via an associated website), the process 900 may be preceded by a user providing certain useful information (e.g., location characteristic information, authorization(s) to track the online activity of the user, etc.) to the marketing offer server 130. For example, a user may provide to the marketing offer server 130 (e.g., at a time of registering with the server or another time) information that would may prove useful in determining the user's current or future location. For example, users might be asked to enter two city pairs as part of a contest to encourage downloading of the browser plug-in. One user is selected at random and wins airline tickets between those city pairs. The first city of the pair is most likely at or near the user's home city, and thus provides additional corroborating evidence as to the location of the user above and beyond an IP address. Users might also be asked where they work or what highways that they most often travel. Such information could again help to more precisely identify the location of a user. In one embodiment, users are presented with a digital map upon registration and are asked to trace out a path on that map (e.g., using their finger if the device is comprises a touch screen), showing routes that they often drive, such as a work commute the path to a frequently visited friend. Access to such information may facilitate the ability of the marketing offer server 130 to output coupons or other types of marketing offers not merely based on a user's current location, but based on a location the user is likely to be at some point in the future (e.g., along a commuting path of the user, at a travel destination the user indicates he has plans to visit, etc.).

In 904, one or more location characteristic(s) of a user or user device are determined (e.g., based on information retrieved from a memory or based on information received directly from a user device). In some embodiments, a location characteristic may be determined based on the IP address of a user device. For example, is a location characteristic to be determined is a presumed geographical location of the user based on a presumed geographical location of a user device, an IP address may be quite useful. Several commercially available online services allow one to search for the geographic location associated with an IP address by entering it into a simple Web form. Two popular services are Geobytes™ and IP2Location™. Each of these services utilizes a proprietary databases of addresses based on Internet traffic flow and Web site registrations. The databases can be purchased as a downloadable package for that purpose. In some embodiments, once an associated geographic location associated with an IP address received from a user device is received, such geographic location may be used as the presumed geographic location of the user for purposes of determining whether the user qualifies for a coupon or other type of marketing offer. In other embodiments, step 904 may comprise determining a location characteristic based on data other than (or in addition to) an IP address of a user device. For example, information (e.g., answers to questions output to the user, such as upon the user registering for the services offered by marketing offer server 130) may be utilized to determine a location characteristic of the user.

In some embodiments, the IP address of a user device may be received from the user device each time the user launches a web browser and/or the web browser plug-in, initiates a new search using a search engine, or may be received only for particular searches. With respect to the latter, in some embodiments an IP address (and/or an indication of online activity such as the terms provided by the user to a search engine in conducting a search via a search engine) may only be transmitted to the marketing offer server 130 if the user provides an affirmative request (e.g., an input or instruction such as actuating a link or virtual button of an interface provided via the web browser plug-in). In other embodiments, the IP address of a user device may be stored in a memory (e.g., memory 330 of marketing offer server 300) and retrieved from such memory if a certain qualifying condition is satisfied (e.g., whenever search terms were received from user a user device 110). In other words, in some embodiments the location characteristic (e.g., IP address or based on an IP address) is received or determined only if the user authorized that the location characteristic be transmitted or otherwise obtained at a particular time by the marketing server 130. In some embodiments, a user launching or activating a web browser plug-in when launching a web browser may be considered to be such authorization. In other embodiments, additional authorization may be required for each transmission or determination of a particular online activity event.

In step 906, data defining online activity of the user is received or otherwise determined. As described herein, in one embodiment such data may comprise one or more search terms entered by the user into a web browser of the user device. In another embodiment, such data may comprise an indication (e.g., a URL, tags associated therewith, words found on a web page) of a web page or web site being visited by the user via the user device, an indication of a retailer, service and/or product for which information is being output to the user. As described with respect to step 904, in some embodiments the online activity is received or determined only if the user authorized that the particular online activity be transmitted or otherwise obtained by the marketing server 130. In some embodiments, a user launching or activating a web browser plug-in when launching a web browser may be considered to be such authorization. In other embodiments, additional authorization may be required for each transmission or determination of a particular online activity event.

In step 908, a marketing offer is selected for output to the user. As described herein, the marketing offer (e.g., coupon) may be selected based on both (i) the one or more location characteristic(s) determined in 904 and (ii) the data defining the online activity determined in 906. For example, a database of available marketing offers (e.g., coupon database 355, as may be embodied in coupon database 600) may be accessed to determine whether there is a match between a combination of location characteristic(s) and online activity defined as respective prerequisites for any of the marketing offers stored therein and the combination of location characteristic(s) and online activity received from the user device.

In an embodiment in which the location characteristic comprises a zip code, the location characteristic prerequisite(s) for output of a particular offer may specify (e.g., as illustrated in the embodiment of FIG. 7) that an offer is to be output to the user only if the zip code determined for the user is within a predetermined distance of specified zip code. Accordingly, in some embodiments step 908 may comprise determining whether the location of the user is within the required distance of the location specified for output of the offer.

In one particular example in which the data indicating the online activity comprises one or more search terms entered by the user into a web browser, step 908 may include determining if there is a match (or more than one match) between the user search terms and the search terms stored for the available coupons or other types of marketing offers. In one embodiment, finding a match between the search terms entered into a search engine by a user and the search terms stored as prerequisites for an output of a particular coupon or other type of marketing offer may comprise usage of Boolean operators (e.g., by including functionality to exclude a particular term such that any search with that term would result in no match, even if all of the other search terms matched).

In accordance with some embodiments, a plurality of coupons or other types of marketing offers may match a given combination of location characteristic(s) and online activity received from a user device. In such an embodiment, each of the plurality of coupons or other types of marketing offers may be transmitted to the user device for output to the user or a subset (e.g., one) of the coupons or other types of marketing offers may be selected. In either scenario, if more than one coupon or other type of marketing offer is selected for transmission to a user device, an order may first be determined for how the coupons (or other types of marketing offers) are to be output to the user.

In some embodiments, the coupons (or other types of marketing offers) may be ranked based on one or more factors. Examples of such factors include, without limitation, (i) relevancy to the online activity and/or location characteristic of the user; (ii) category of the coupon (e.g. coupons relating to DVDs would be ranked higher than coupons relating to clothing products if the user had been searching for information on a DVD); (iii) the magnitude of the coupon (e.g. coupons providing the highest absolute value of dollar savings are ranked highest, or coupons with the largest percentage savings are ranked highest), and (iii) the user's history. The user's history may include, for example, what the user has clicked on or otherwise expressed interest in during his online activities (e.g. clicking on lots of DVD product pages results in DVD coupons being ranked higher), what coupons the user has previously sough additional information on and/or or what coupons the user has already redeemed (e.g. coupons similar to those already redeemed or printed are ranked higher). In one embodiment, a maximum number of coupons (or other types of marketing offers) is established and step 908 may comprise selecting a subset (e.g., the top five most highly ranked) coupons to be transmitted to the user device for output to the user.

The ranking of coupons may, in some embodiments, include taking into account the location of the user as compared to a location of a merchant location at which the coupon may be redeemed. In such an embodiment, a ranking function may initially rank the coupon by a magnitude of the offer savings, but scale or weight the ranking up or down based on the distance of the user (whether current or future location of the user) relative to the merchant location. For example, the coupon may be ranked down if the user is determined to be relatively farther away (or outside of a predetermined optimal distance or distance range) from the merchant location and ranked up if the user is determined to be relatively (or within a predetermined optimal distance or distance range) to the merchant location. Thus, a relatively small value coupon might be ranked ahead of a higher value coupon if the small value coupon was for a merchant right around the corner from where the user is determined to be.

In step 910, the one or more coupons or other types of marketing offers are transmitted to the user device (e.g., the user device from which the IP address and/r online activity data was received). For example, data defining the one or more coupons or other types of marketing offers (e.g., text and/or graphics) may be transmitted, along with any instructions for outputting the coupon(s) (e.g., an order or format for the output). In some embodiments utilizing a web browser plug-in, the web browser plug-in previously downloaded by the user to the user device may be programmed to receive such data and output the one or more coupons in a predetermined format (e.g., in a predetermined area of the web browser, etc.).

It should be noted that in some embodiments the coupons (or other types of marketing offers) to be output to the user may be output (or transmitted for output) essentially simultaneously with the user's search or participating in another type of online activity which triggered the selection and output of the coupons (e.g., the coupons may be output at the same time as the search results for the search are output or while the user device is visiting the URL or product information which qualified the user for output of the coupon). In other embodiments, however, some time may pass between the determination of information which qualifies a user for output of a particular coupon (e.g., a determination of a location characteristic and/or online activity of user) and the output (or transmission for output) of the coupon. For example, the coupon may be output to the user after the user completes the online activity which qualified the user for the output of the coupon (e.g., after the user leaves a web page showing search results of a particular search or leaves a particular URL). In some embodiments, for example, the one or more coupons may be output to the user the next time the user launches the web browser and/or web browser plug-in.

In some embodiments, process 900 (or another process related to process 900) may include additional steps. For example, in some embodiments a merchant on whose behalf a coupon or other marketing offer was output to a user may be charged a fee in exchange for the output. In such embodiments, an additional step of charging an account of the merchant for the output of the coupon may be employed, or noting in a memory that the coupon was transmitted for output such that the financial account of the merchant may subsequently be updated based on this indication. For example, in some embodiments a merchant may be charged a predetermined fee for each coupon transmitted for output to a user device or for every predetermined number of coupons so transmitted (a batch fee may be charged for every 100 coupons so transmitted).

In some embodiments, a merchant may be charged based on a response of the user to the output of a coupon or other marketing offer. For example, a merchant may be charged for each coupon a user (i) clicks on or otherwise selects; (ii) prints out or downloads; and/or (iii) redeems. In such embodiments, the process 900 (or another process related to process 900) may be operable to receive from the user device (or from a merchant server) an indication of a user response to an output of a particular coupon (or other marketing offer), store the indication, and charge a financial account of the merchant appropriately. For example, in some embodiments a merchant may pay five cents to the location based marketing offer service for every coupon clicked on by the user, or pay ten cents for every coupon printed out by the user. Alternate formulas based on which a merchant may pay fees to the location based marketing offer service include, without limitation, paying per call initiated by a user (could require a minimum threshold length of call before triggering a charge) to learn more information about an offer output to the user, paying per coupon printed by the user, paying for each key word defined in an online activity prerequisite defined by a coupon, paying for coupon placement on a particular website, and the like.

Accordingly, in some embodiments information regarding one or more selections of coupons (or other types of marketing offers) maybe received from a user device 110. Such information may indicate, for example, which (if any) coupons have been redeemed or viewed by a user. In one example embodiment, selection data may include an identifier of any coupons transmitted to the user which the user clicked on. In one embodiment, selection data might be received over a period of time as the user reviews and/or redeems the coupons or other types of marketing offers output to the user. In some embodiments, selection data may be received from a user device 110. In other embodiments, selection data (e.g., redemption data) may be received from a merchant 120.

While various embodiments have been described herein, it should be understood that the scope of the present invention is not limited to the particular embodiments explicitly described. Many other variations and embodiments would be understood by one of ordinary skill in the art upon reading the present description. For example, the systems and methods of the present disclosure may be applied to marketing offers comprising price comparisons. For example, in one embodiment if it is determined that a user is viewing a web page describing a product being offered for sale by a particular retailer, information comprising one or more price comparisons may be output to the user based on the location of the user (e.g. only price comparisons for local merchants within five miles of the user's location are provided to the user).

In another embodiment, the marketing offer output to a user may comprise a price matching certificate from a competing merchant. For example, as described herein in one embodiment the online activity determined for a user or user device may comprise determining that the user is viewing information (e.g., a web page) about a particular product. In such an embodiment, the marketing offer output to the user may comprise a price matching certificate from a merchant who is a competitor of the merchant who is offering the product for sale as is being viewed by the user on the web page. For example, in one embodiment Merchant A may register with the location based marketing offer service to output a price matching certificate for any product being offered by Merchant B. Thus, if the marketing offer server 130 determines that a user is viewing information about a product being offered for sale by Merchant B (i.e., the online activity of the user satisfies the prerequisite online activity defined by Merchant A), the marketing offer server 130 may cause a user device of the user to output a price matching certificate for the product from Merchant A (e.g., if a location characteristic of the user satisfies a location characteristic defined for this offer by Merchant A). In some embodiments, the price matching certificate data is filled in based on the online activity of the user. For example, the particular product that is the subject of the price matching certificate is determined based on the name of the product as determined from the web page of the product the user is viewing. For example, a particular field (e.g., a product name field) of the price matching certificate may be populated by the marketing offer server 130 based on the information received from the user device.

### Rules of Interpretation

Numerous embodiments have been described, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention. Accordingly, those skilled in the art will recognize that the present invention may be practiced with various modifications and alterations. Although particular features of the present invention may be described with reference to one or more particular embodiments or figures that form a part of the present disclosure, and in which are shown, by way of illustration, specific embodiments of the invention, it should be understood that such features are not limited to usage in the one or more particular embodiments or figures with reference to which they are described. The present disclosure is thus neither a literal description of all embodiments of the invention nor a listing of features of the invention that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise. The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, TDMA, CDMA, and 3G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device that accesses data in such a database.

For example, as an example alternative to a database structure for storing information, a hierarchical electronic file folder structure may be used. A program may then be used to access the appropriate information in an appropriate file folder in the hierarchy based on a file path named in the program.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning.

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

What is claimed is:

1. A method for facilitating a provision of an offer to a user, the method comprising:
determining, by a processor of a computing device, online activity of a user;
determining, by the processor, a unique identifier of at least one of the user and a user device associated with the user;
determining, by the processor and based on the unique identifier, a location characteristic of the user;
determining, by the processor, a marketing offer to be output to the user based on the online activity of the user and the location characteristic of the user; and
transmitting, by the processor, the marketing offer to the user device.

2. The method of claim 1, wherein determining online activity comprises receiving, from the user device, an indication of information sought out by the user using the user device, the information regarding at least one of a product, retailer and service.

3. The method of claim 2, wherein receiving an indication of information sought out by the user comprises receiving at least one search term input by the user into an online search engine.

4. The method of claim 2, wherein receiving an indication of information sought out by the user comprises receiving an indication of at least one of a web page, web site, URL, product description and service description output to the user via the user device.

5. The method of claim 1, wherein the unique identifier comprises at least one of (i) an IP address of the user device, (ii) a GPS-determined location of at least one of the user and the user device and (iii) login credentials of the user for receiving the marketing offer.

6. The method of claim 1, wherein the location characteristic comprises at least one of (i) an address of the user, (ii) a zip code; (iii) a city and state designation; (iv) a country; (v) a latitude and longitude designation; (iii) a location associated with a commuting route of the user, and (iv) a travel destination of the user and a location likely to be visited by the user.

7. The method of claim 1, wherein determining online activity of the user comprises receiving, from a web browser plug-in stored on the user device, data defining the online activity of the user.

8. The method of claim 1, wherein determining a unique identifier of the user comprises receiving, from a web browser plug-in stored on the user device, the unique identifier.

9. The method of claim 8,
wherein receiving, from the web browser plug-in stored on the user device, the unique identifier comprises receiving, from the web browser plug-in stored on the user device, an IP address of the user device; and
wherein determining a location characteristic of the user comprises determining a zip code associated with the user based on the IP address of the user device.

10. The method of claim 1, wherein the marketing offer comprises at least one of a digital coupon, a price matching certificate and a promotional code, any of the foregoing redeemable at a specified merchant location associated with the location characteristic.

11. The method of claim 10, wherein determining the marketing offer comprises selecting a marketing offer for a merchant location which is within a predetermined distance from a location defined by the location characteristic of the user.

12. The method of claim 1, further comprising:
receiving, from the user device, a request to download a web browser plug-in to the user device, wherein the web browser plug-in is operable to modify the operation of a web browser of the user device such that that the web browser transmits data indicating at least one of online activity of the user device and an IP address of the user device to a third party server; and
downloading the web browser plug-in to the user device.

13. The method of claim 12, wherein the web browser plug-in is further operable to modify the operation of the web browser such that the web browser is operable to output to the user the marketing offer.

14. An apparatus operable to communicate, over the Internet, with a plurality of user devices, the apparatus comprising:
a processor for controlling the apparatus;
a memory, the memory storing a program comprising instructions, which instructions when executed by the processor cause the processor to perform a method, the method comprising:
determining online activity of a user;
determining a unique identifier of at least one of the user and a user device associated with the user;
determining, based on the unique identifier, a location characteristic of the user;
determining a marketing offer to be output to the user based on the online activity of the user and the location characteristic of the user; and
transmitting the marketing offer to the user device.

15. The apparatus of claim 14, wherein determining online activity comprises receiving, from the user device, an indication of information sought out by the user using the user device, the information regarding at least one of a product, retailer and service.

16. The apparatus of claim 15, wherein receiving an indication of information sought out by the user comprises receiving at least one search term input by the user into an online search engine.

17. The apparatus of claim 15, wherein receiving an indication of information sought out by the user comprises receiving an indication of at least one of a web page, web site, URL, product description and service description output to the user via the user device.

18. The apparatus of claim 14,
wherein determining online activity of the user comprises receiving, from a web browser plug-in stored on the user device, data defining the online activity of the user; and
wherein determining a unique identifier of the user comprises receiving, from a web browser plug-in stored on the user device, the unique identifier.

19. The apparatus of claim 14,
wherein receiving, from the web browser plug-in stored on the user device, the unique identifier comprises receiving, from the web browser plug-in stored on the user device, an IP address of the user device; and
wherein determining a location characteristic of the user comprises determining a zip code associated with the user based on the IP address of the user device.

20. The apparatus of claim 14, wherein determining the marketing offer comprises selecting a marketing offer for a merchant location which is within a predetermined distance from a location defined by the location characteristic of the user.
